(19) United States
(12) Patent Application Publication
(10) Pub. No.: US 2015/0154628 A1
(43) Pub. Date: Jun. 4, 2015

(54) System and Method for Multi-Entity Funded Prescription Benefit Card

(71) Applicant: Inflectionpoint Healthcare Inc., Saint John (CA)

(72) Inventor: Robert Joseph Dufour, Rogers, AR (US)

(21) Appl. No.: 14/617,484

(22) Filed: Feb. 9, 2015

Related U.S. Application Data
(63) Continuation of application No. 13/598,800, filed on Aug. 30, 2012, now abandoned.
(60) Provisional application No. 61/528,868, filed on Aug. 30, 2011.

(51) Int. Cl. G06Q 30/02; G06F 19/00; G06Q 50/22

(52) U.S. Cl. CPC G06Q 30/0226; G06Q 40/08; G06Q 50/22; G06F 19/328

(57) ABSTRACT

A system and method are provided to aggregate benefits offered by multiple entities and process prescriptions for these benefits involving, a service provider, one or more prescription benefit management companies or insurers, individual consumers (note: the term consumer, consumers, patient, and patients are used interchangeably), and participating pharmacies. The service provider aggregates incentives available in the marketplace and specific incentives that may be provided that are unique for individual programs. Individual consumers receive the benefits of these incentives when a pharmacy transmits a claim request via their pharmacy computer system to the service provider's database and that request is authorized.

### CROSS REFERENCE TO RELATED APPLICATIONS

This application is a continuation of U.S. application Ser. No. 13/598,800, filed Aug. 30, 2012, entitled “System and Method for Multi-Entity Funded Prescription Benefit Card,” which claims priority to U.S. Provisional Application No. 61/528,868 filed on Aug. 30, 2011, entitled “System and Method for Multi-Entity Funded Prescription Benefit Card,” the contents of which are incorporated herein by reference.

### BACKGROUND

Various discounts, incentives and assistance programs are available to consumers to offset the cost of medications, products, and services. Such discounts, incentives and programs are offered through various media outlets such as radio, print, television, Internet, and telephonic communications. These methods have various levels of success, but most often are independent offers with little or no aggregation of benefits.

As a result, consumers often pay a premium for medications, products, and services because of a lack of knowledge and utilization of the programs available in the marketplace. This lack of knowledge and utilization is in part due to the lack of recognition by the consumer and/or the pharmacy provider, and the timing of the need to apply such discounts, incentives and programs. For example, such discounts, incentives and programs typically need to be applied in advance of, or at a time of, a transaction for a particular medication, product and service.

### SUMMARY

Disclosed herein are systems and methods for automatically determining and applying incentives during a claim adjudication process. The present disclosure describes systems and methods that will save the customer money, save the pharmacist time, and increase the utilization of incentives offered in the marketplace.

In accordance with some implementations, there is provided a method of integration of discounts, incentives, and assistance offered independently in the industry. The method coordinates these various programs to automate the identification of benefits available and to facilitate the transaction of these benefits providing efficiency for the pharmacy provider and the consumer.

Offers of discounts, incentives, and assistance are aggregated to a database, thus facilitating transactions of these benefits. The database of available incentives, discounts, loyalty programs, free goods, patient-based outcomes incentives, medication therapy management (MTM) programs, disease state management, and other beneficial offers (hereinafter referred to as “benefits”) are maintained by, e.g., a service provider. These benefits may also include pharmaceutical manufacturers' patient assistance programs, co-pay assistance programs, and other marketing programs offered by pharmaceutical manufacturers that may improve compliance, persistence, or gain market share for their products.

In addition to pharmaceutical manufacturers, other benefits or incentives may be included that are offered by other entities, such as retail pharmacies providing discounts or free goods on medications, OTC (over the counter) products, and other wares and services offered by the retailer, additionally incentives may be offered by other entities such as suppliers, non-profit groups, the government, insurance companies, hospitals, medical groups, associations, and others who conduct business related to healthcare. Collectively these offers are hereinafter referred to as benefits.

In accordance with methods of the present disclosure, a consumer may obtain, e.g., a loyalty, reward, or other incentive (i.e., “a card”) from a grocery store, pharmacy, warehouse club, etc. (a retailer) that provides medications, OTC products, and other wares and services. Additionally by way of example and not limitation, other entities could provide loyalty, reward, or other incentive cards (the card) in the marketplace e.g., Insurance companies, PBM's (pharmacy benefits administrator), Associations, and Marketing companies. As part of the process to obtain the loyalty, reward, or other incentives, the consumer may provide information to enable the coordination of the benefits with other benefits for which they are eligible, or to provide benefits as a primary benefit. For example, the consumer may provide insurance related information that is stored in a retailer's computer system and may be used in accordance with NCPDP standards. Information needed for the loyalty, reward, or other incentive (the card) will be collected and stored in the Pharmacy computer system or the Database for benefits aggregated to be used as part of an automatic benefit request from a retailer (e.g., pharmacy provider) to a service provider's database during future consumer transactions for new and refill prescription requests. The service provider aggregates incentives available in the marketplace.

Benefits are realized by consumers when eligible transactions are requested by the retailer (e.g., a pharmacy provider) and authorized by the service provider. Consumers participating in these services automatically have each of their prescription requests checked against the service provider's database of available benefits. Thus, the consumer needs only to enroll into one program to be automatically eligible for a multitude of aggregated benefit programs. Also, the consumer no longer needs to manage the details of each benefit program, incentives and benefits are managed by the system saving the members time and effort from enrolling in a multitude of benefit programs. As such, the systems and methods of the present disclosure provide for persistency in the incentive programs, consumers' insurance fields remain populated at the retail level, which encourages use of the benefits.

### BRIEF DESCRIPTION OF DRAWINGS

A more complete understanding of the present invention may be obtained by considering the following description in conjunction with the drawings in which:

FIGS. 1A and 1B are schematic diagrams of a system in accordance with principles of the present disclosure illustrating various data flows within the system;

FIG. 2 further details the database of FIGS. 1A and 1B;

FIG. 3 further details the cards of FIGS. 1A and 1B;

FIG. 4 is an operational flow diagram in accordance with the present disclosure; and

FIG. 5 is an exemplary computing device.

### DETAILED DESCRIPTION

For the purposes of introduction, incentives and benefits in the pharmacy industry number in the hundreds if not thousands, and are offered to the public for both cash payers and to those consumers who have prescription benefit programs. By way of non-limiting examples, publicly offered incentives and benefits include retailer specific benefits such as free antibiotics, $4 generics for a 30 day supply, and special low pricing for 90 day supply of generics. Pharmaceutical companies offer benefits such as free goods, reduced co-pay, and patient assistance programs. For the top 200 brand-named drugs in 2009, over 20% of those medications have benefits offered by pharmaceutical manufacturers.

The pharmaceutical industry product management teams, marketing programs, and sales teams are tied closely to manage care and government benefit programs. Pharmaceutical executives for these companies must navigate between paying rebates, cash pricing, patient assistance programs, and marketing direct to the consumer. They also must navigate regulatory and statutory compliance such as state prohibitions (e.g., Massachusetts) and excluded plans (e.g., Government programs, TriCare, DOD, Medicaid, Medicare, etc.) for many of their benefit programs.

Retailers offer various benefits such as $4 generics, free antibiotics, and other incentives to drive loyalty and sales of consumers to their pharmacies. Benefits are also offered at times by associations, insurance companies, and health related business to attract consumers to their business. Awareness by the consumer and the pharmacy provider of these various programs offered by pharmaceutical companies, insurance companies, associations, retail pharmacies, consumer product goods companies, and others in the healthcare industry is a limiting factor to the utilization of these benefits. Also the pharmacy provider under current systems must enter the consumer information, RX BIN number, and other data required of each individual program specific to that program each time the consumer request a new prescription or a different prescription product. This often results in changing out secondary insurance information in the pharmacy provider computer system for consumers with primary insurance or changing out primary insurance fields for cash customers. Each program that a consumer wants to participate in requires the pharmacy provider to change these insurance fields. This creates a lot of frustration and time demands on pharmacy providers.

Implementations of the present disclosure reduce the requirement of pharmacy providers entering data multiple times into consumer insurance fields depending on various products. As such, pharmacy providers may enter information into the insurance fields for consumers on their pharmacy computer system and utilize this information for multiple program benefits contained in the service provider's database with one RX BIN and one consumer ID number.

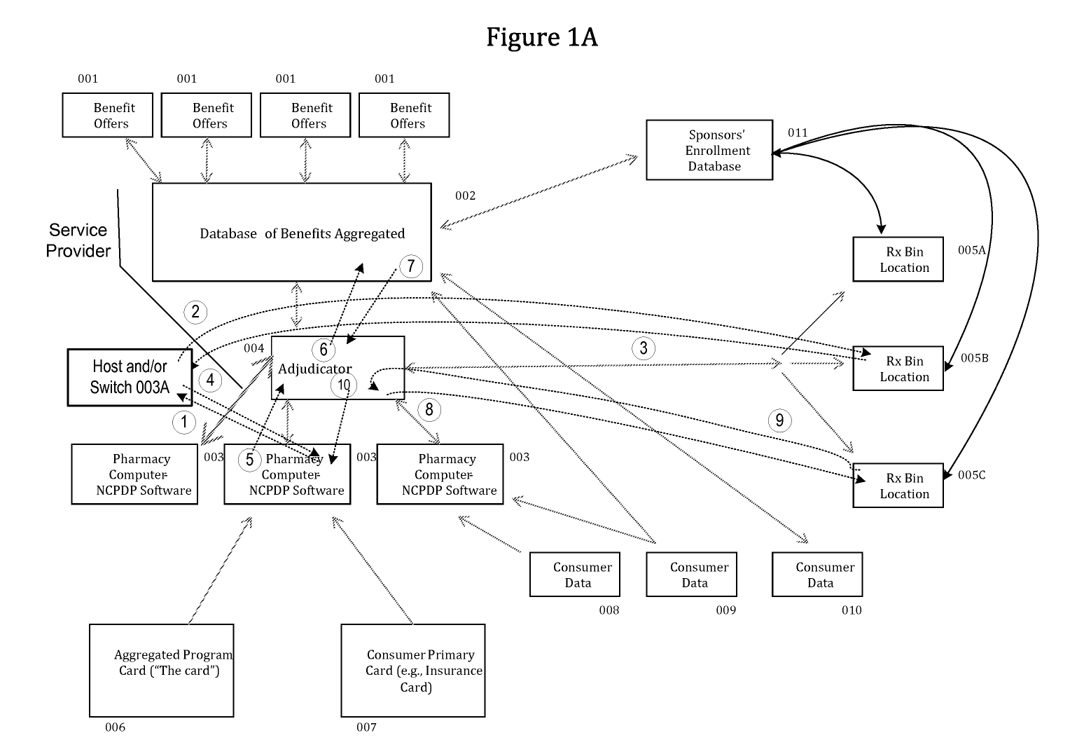

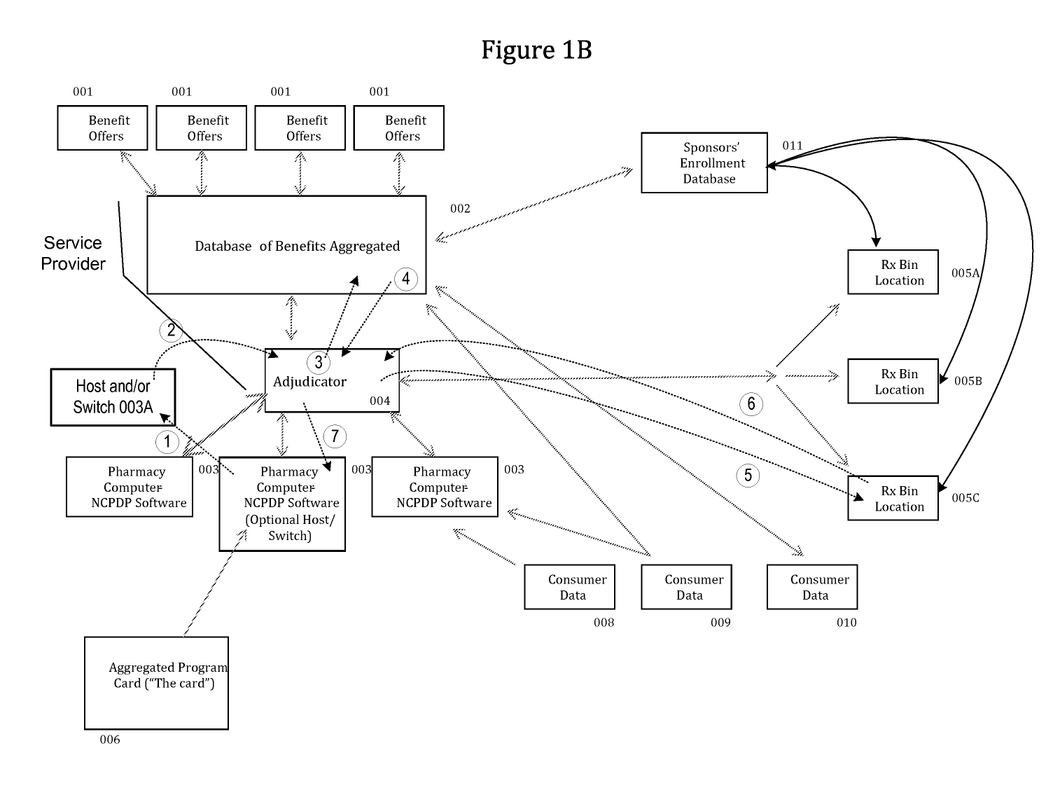

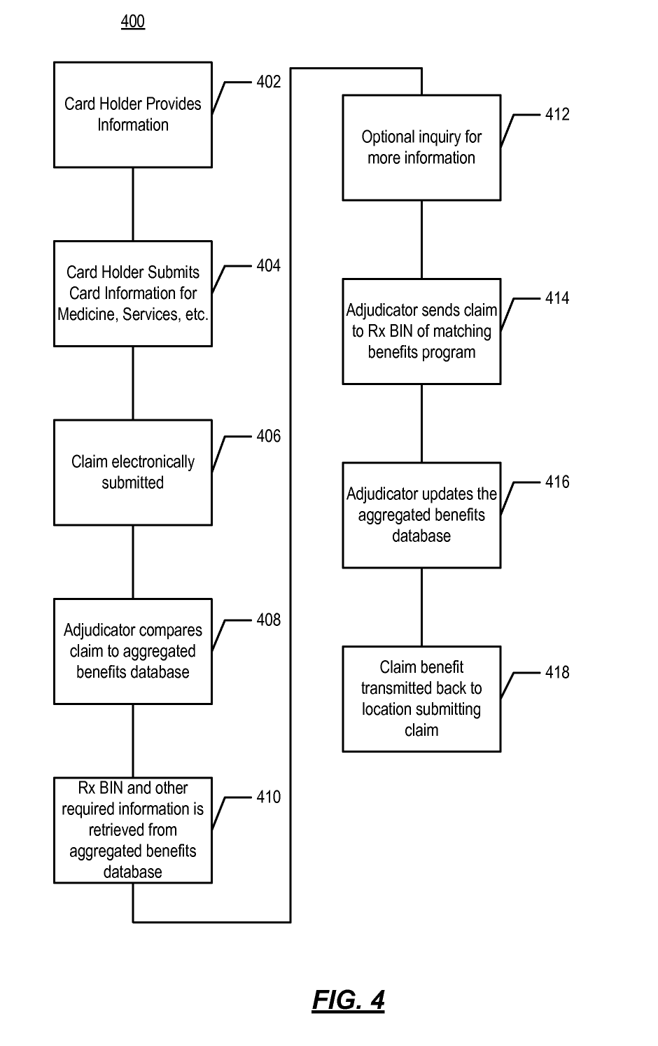

With reference to FIGS. 1A and 1B, there are shown schematic diagrams of a system in accordance with principles of the present disclosure illustrating various data flows within the system. The data flows, in dashed lines, will be described below with reference to FIG. 4. Multiple offers 001 include, but are not limited to, pharmaceutical manufacturers copay assistance programs, patient assistance programs, free goods, loyalty programs, percent off copay programs, and other commonly marketed pharmaceutical programs. Other offers 001 may include but are not limited to retailers' benefits such as free medications, discounted generics, free OTC goods, and free or discounted wares and/or services. Other similar type goods and services may be offered by associations, hospitals, medical groups, consumer product companies and others associated with health care benefits.

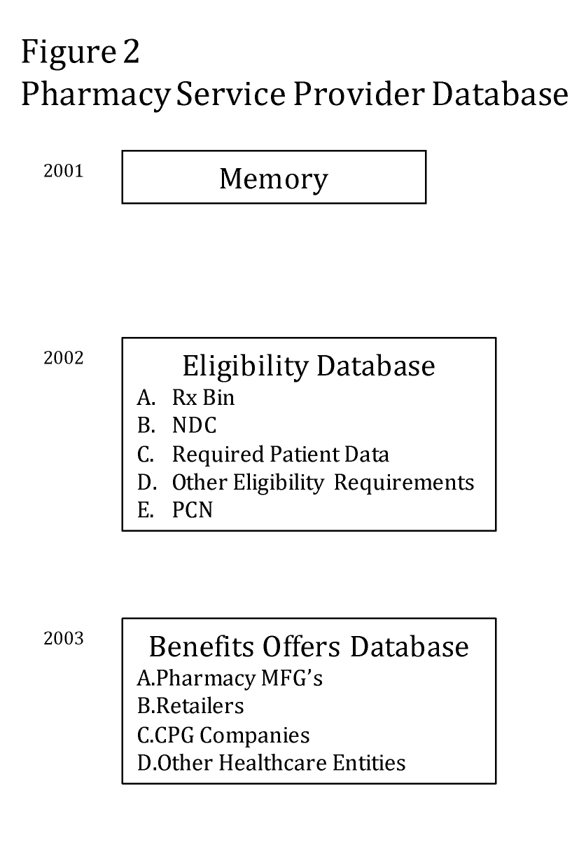

An database of benefits aggregated 002 may be used to store and index benefits offered in the marketplace, such as those identified by reference numeral 001. The database of benefits aggregated (002) may also store consumer (i.e., patient) eligibility data. The database of benefits aggregated (002) are further illustrated in FIG. 2. Reference numeral 2002 represents typical elements of eligibility. In particular, Rx BIN (2002A) is an Rx BIN number associated with an individual offer within the offers (001). The Rx BIN number is a 6 digit number that informs a retailer (e.g., a pharmacist or service provider) which company will reimburse the retailer for the cost of the prescription and to where to send a claim for reimbursement. Reference number 2002E is a PCN number (Processor Control Number), which may be up to 10 digits and more specifically directs the claim within the individual Rx Bin processor.

A National Drug Code (NDC) (2002B) of covered prescription drug of an offer within the offers (001) may be stored. Other elements of (2002B) may include a UPC number, or other unique number representing a product or service. Consumer data (2002C) may be information, such as required consumer data elements as specified by various offers (001) offered in the market place. Such consumer data (2002C) may include, but are not limited to date of birth, age threshold, specific medication, how many times a medication has been taken, time/date, medical condition, address, phone number, or other information. Other data elements (2002D) may include the pharmacy provider NPI number, physician required data such as NPI, date, or other common NCPDP standard elements.

Various benefits (2003) may be available to the consumer. For example, benefits (2003A) may be available from pharmacy manufacturers as sponsors or their marketing arms. Benefits (2003B) may be offered by various retailers or pharmacies, such as goods, discount, or services. Benefits (2003C) may also be offered from suppliers or vendors, such as but not limited to, consumer packaged goods (CPG) companies. Benefits (2003D) represents as may be made available in the market place by other businesses associated with healthcare.

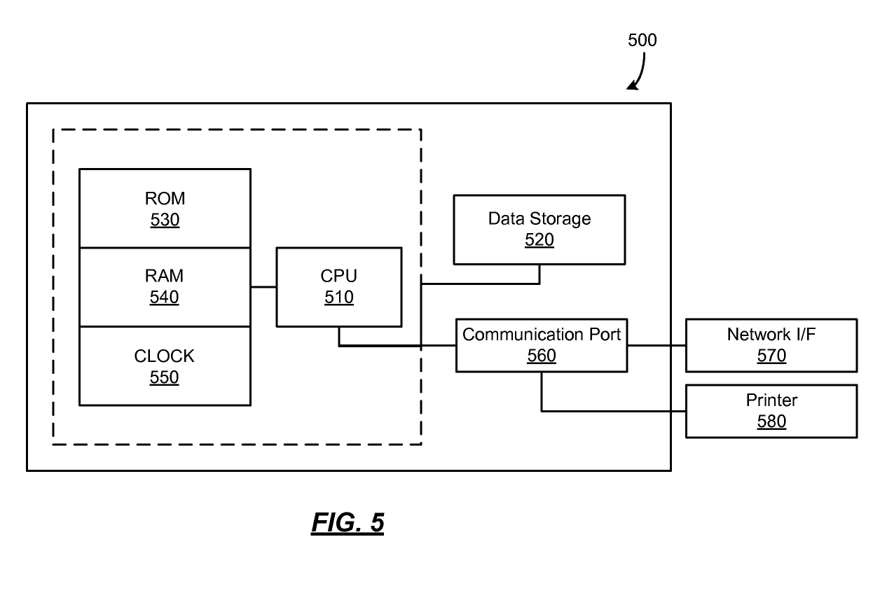

Referring again to FIGS. 1A and 1B, various pharmacy computer systems (003) may store and/or transmit data for benefit adjudication according to NCPDP guidelines. In some implementations, the pharmacy computer systems (003) may communicate directly with other entities. In some implementations, the pharmacy computer systems (003) may communicate data to a host and/or switch (003A) (or to one or both of the host and switch) before the data is relayed to other entities, as described below. An example computer system is shown in FIG. 5, and may include store terminal data, host systems, or other systems that are compatible with a pharmacy operating dispensing system.

An adjudicator (0040 utilizing NCPDP standards and other national standards is provided. The features and operation of the adjudicator (004) include by way of example and not limitation, the ability to adjudicate claims for requests appropriate to Rx BIN numbers of the adjudicator, forward claims appropriately to other Rx BIN locations for adjudication, receive and process responses and requests appropriately, ability to communicate with pharmacy computer systems, hosts systems, switches, and other Rx BIN adjudicators. Also, the adjudicator (004) in this disclosed system and method has the features and functionality to communicate with the database of benefits aggregated (002) for the purpose of processing benefits and consumer eligibility data. The features and operation of adjudicator (004) are known by those of ordinary skill in the art. Other adjudication systems (005A-005C) and switches may be included in the system of FIGS. 1A and 1B. These may be primary locations such as RX BIN (005A, 005B, 005C) that process specific incentives and offers (001) in the industry.

A consumer benefit card (herein an “Aggregated Program Card”) (006) may be an electronic, paper, or plastic loyalty/reward form, card, or other indicia with NCPDP compatibility. This card may be representative of the benefit as described in this invention. In other words, a consumer may as way of example but not exclusive, sign up for a retail discount pharmacy card or other branded or non-branded benefit and use this card as a primary card, or may be a secondary, tertiary, or other subordinate benefit card. This card has the functionality of providing data which may be necessary for eligibility or other processing requirements for one or more of the following: the database (002) for the aggregated benefits, adjudicator (004), Rx BIN (005A-005C), sponsors' enrollment database (011), pharmacy computer (003), and or host/switch (003A). These include but are not limited to insurance, free good offers, co-pay assistance, and other benefits in the marketplace.

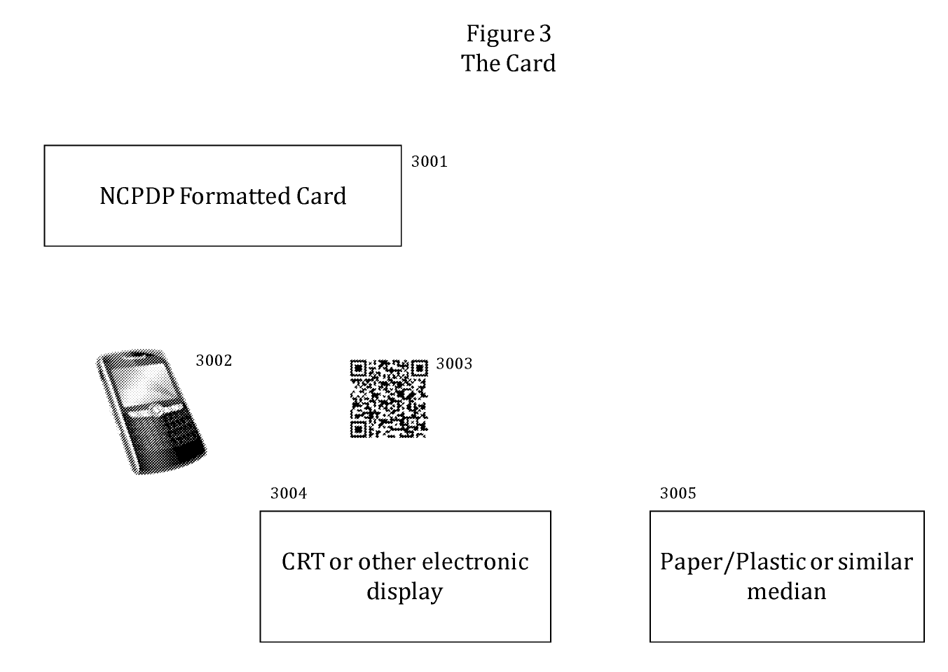

As will be described below in the operational flows of the present disclosure, consumer data (008) may be received and input into the pharmacy system (003) and associated with the card (006) or a primary (e.g., insurance) card (007). It is noted that the card (006) and primary card (007) are illustrated to represent that consumers may have and may apply more than one card for benefit (see e.g., FIG. 1A). The card (006) may be used for loyalty programs, retail programs, association programs, insurance programs, and others in the health related field. In addition, the card (006) may be a primary, secondary, tertiary, or other subordinate card. FIG. 3 illustrates example implementations of the cards (006 and 007). As non-limiting examples, the cards may be a NCPDP formatted card (3001), a mobile device (30020 (near-field communications, or other), a Quick Response (QR) code (3003), a display device (3004) or a conventional plastic/paper card (3005).

Referring again to FIGS. 1A and 1B, the card (006) may be entered as primary insurance under NCPDP guidelines when the consumer may not have other benefits available. For consumers who do have some form of a prescriptions benefit, which is the more common occurrence, this data associated with the card (006) would be entered into the pharmacy system (003) as a secondary, tertiary, or other subordinate for benefit adjudication, other than primary insurance. When this latter case occurs, prescriptions are filled for a consumer and the pharmacy system may transmit to a primary payor or other prior-ordinate payor (e.g., such as traditional insurance) then the pharmacy system would transmit the consumer data and coordination of benefits data to the Rx BIN associated with the adjudicator (004). FIG. 4 which will be discussed in greater detail further below in this document describes the data flow with respect to the card (006) unless specific reference otherwise to other prior ordinate payors (card 007).

Consumer data (008) reflects data that is normally collected by the pharmacy from the consumer in the regular course of business. By way of a non-limiting example, such data (008) may include patient first name, patient last name, address, date of birth, and other NCPDP standard data. It is expected that consumer data (008) will be collected from a vast majority of the holders of the card (006) either at the pharmacy (003) or by the service provider during enrollment.

Consumer data (009) may include data that may not always be transmitted with most NCPDP claims. This data may be collected and entered into the pharmacy computer system (003) or the database of benefits aggregated (002). As a non-limiting example, this data may include the consumer's cell phone number, email address, personal health data, lab values, and other data. Such consumer data (009) is information that the consumer may wish to share with a more limited distribution and under circumstances where sharing is required. For example, a consumer may provide a cell phone number to the service provider only under circumstances where the service provider must contact the consumer to complete a transaction.

Consumer data (010) may include data that is less often found in pharmacy systems (003) and transmitted via NCPDP. For example, this data may include, but is not limited to, a specific requirement to the incentive program for eligibility. For example, a medication for depression may ask the patient, “Have you been diagnosed with depression?” Other examples may be lab values, a health and wellness data for outcome based programs. Many other examples of unique questions or requirements are found on enrollment or during participation in individual incentive programs or health based programs. This data will be collected from the consumer/patient and stored in the database of benefits aggregated (002) or entered into the pharmacy computer system and transmitted to the adjudicator (004).

This data (008, 009, 010) may be collected in a variety of ways, such as through emails, websites, text messaging, QR codes, phone calls, or direct communication at the pharmacy level.

FIG. 4 illustrates an operational flow (400) in accordance with the present disclosure with respect to benefit associated with card (006) unless specifically referenced otherwise. At 402, a cardholder provides consumer data to the pharmacy or service provider to enroll into program benefits provided by use of the card (006). This data may be represented by data (006, 007, 008, 009, and 010), described above. The operation at 402 may occur at any time prior to or after the subsequent operations described below.

At 404, the card holder may submit to the pharmacy the card (006), or if information associated with the card 006 was previously entered into pharmacy computer (003), the information may be retained by the pharmacy computer system 003 without requiring consumer to present card for benefit request.

At 406, a pharmacist electronically submits a claim in accordance with the NCPDP standards. FIG. 1A illustrates an implementation where the consumer provides both the primary card (007) together with the aggregated program card (006). Information such as the Rx BIN number of the primary card (007), the identifier of the card holder, cardholder or dependent information, the NDC code for the prescription may be communicated from the pharmacy computer systems (003) to a host and/or switch (003A), as shown in FIG. 1A (data flow 1). The host and/or switch (003A) may then send the NCPDP claim information or other information to, e.g., Rx BIN (005B) (dataflow 2; FIG. 1A). The Rx BIN (005B) may process the claim and return it to the sending host and/or switch (003A) (dataflow 3; FIG. 1A). The host and/or switch (003A) may then return the processed claim to the pharmacy computer systems (003) (dataflow 4; FIG. 1A), with the consumer benefit and co-pay amount determined. It is noted that in some implementations, the pharmacy computer systems 003 may communicate directly with, e.g., Rx BIN (005B) without the intermediate data transfer to the host and/or switch (003A).

The pharmacy computer systems (003) may next forward the Rx BIN number of the aggregated program card (006), the identifier of the card holder, cardholder or dependent information, the NDC code for the prescription, and other required fields as required via NCPDP or specific to the Aggregated Program to adjudicator (004) for processing (data flow 5; FIG. 1A).

The data flows to determine whether there exists any additional benefits that the consumer may take advantage of, as described above, to offset the costs of medicine and pharmaceutical supplies/services.

In some implementations, at 406, where the consumer does not have a primary insurance card (007), the consumer may present only the aggregated program card (006). FIG. 1B illustrates such an example. Here, the pharmacy computer systems (003) may forward the Rx BIN number of the aggregated program card (006), the identifier of the card holder, cardholder or dependent information, the NDC code for the prescription, and other required fields as required via NCPDP or specific to the host and/or switch 003A (data flow 1; FIG. 1B). The host and/or switch (003A) then sends the information to the Aggregated Program to adjudicator (004) for processing (data flow 2; FIG. 1B). In some implementations, the pharmacy computer systems (003) may first send information directly to the adjudicator (004).

At 408, the claim information is compared against the database of benefits aggregated to determine if a matching benefits program exists (data flow 6; FIG. 1A/data flow 3; FIG. 1B). An alternative to this step at 408 would be for the database of aggregated benefits (002) to provide files to the adjudicator (004) giving the adjudicator the ability to determine if a matching benefit to claim where available prior to transmission to the Database of benefits aggregated (002). If no benefits are available an appropriate response is routed back to pharmacy computer (003). If a matching benefit is available the claim proceeds to step 410.

At 410, the RX BIN and other associated information such as benefit identifier (cardID), groupID, etc.) are retrieved from the database of benefits aggregated. If there is a matching benefit, the match is returned to the adjudicator (004) (data flow 7; FIG. 1A; data flow 4; FIG. 1B).

At 412, if necessary, additional information may be requested and provided by the consumer or others. For example, this information (010) may be requested from the consumer through a follow-up phone call, email, text, in-person request, etc. to obtain the additional information (010) required of the incentive sponsor's adjudicator, e.g., Rx BIN 005. This information may be stored in the database of benefits aggregated (002) and utilized to populate fields of enrollment required by the sponsor (011) or Rx BIN location (005A-005C).

At 414, the adjudicator sends a claim to the Rx BIN of the matched benefits program using the information in the originating pharmacy claim and information from the match in the database of benefits aggregated, along with any additional information that is required and may have been collected such as from consumer data (009 and/or 010). For example, the information may be forwarded to the Rx BIN of the matched benefits program, e.g., (005C) shown in FIGS. 1A and 1B (data flows 8 and 9; FIG. 1A; data flows 5 and 6, FIG. 1B).

At 416, the adjudicator communicates the response of the claim presented to the Rx BIN to the database of benefits aggregated (002) to reflect the use of the benefit program and to update the database of benefits aggregated (002).

At 418, the adjudicator returns the response to the claim received from the Rx BIN adjudication at (005A, 005B, or 005C) to the pharmacy computer (003) (data flow 10; FIG. 1A; data flow 7; FIG. 1B). Note, in some implementations, the adjudicator may first send the response to the host and/or switch (003A), which would then forward the response to the pharmacy computer (003).

In the operational flow 400, it is noted that steps 416 and 418 may be performed in the reverse order.

Although both FIGS. 1A and 1B illustrate implementations where the adjudicator (004) found only one matching benefits program in the database of benefits aggregated (002) (i.e., that provided by Rx BIN 005C), it is possible there may be multiple matching benefit programs. As such, the data flows 6, 7, 8 and 9 of FIG. 1A and the data flows 3, 4, 5 and 6 of FIG. 1B may repeated until there are no more matching benefits programs and/or the customer's payment amount is reduced to zero.

Thus, as described above, there is an example operational flow of how incentives may be applied without intervention on the part of the pharmacist to identify benefits or to change the patient insurance fields to transmit data directly to Rx BIN of the sponsored incentive. In this manner a consumer is relieved of the burden of having to sign up multiple times and/or search multiple places for possible benefits that may or may not be available to them. By having a loyalty/reward card such as (006) in accordance with the present disclosure, consumers' prescription data is reviewed for benefits that have been aggregated in the database of benefits aggregated (002) and claims are processed by forwarding those claims to appropriate Rx BIN locations (e.g., Rx BIN 005). Responses from the appropriate Rx BIN are sent to the Service Providers adjudicator (004) who may send the response back to the pharmacy system (003).

The present disclosure also provides for a system that relieves pharmacies of the burden of searching for multiple benefits and the burden of changing the data entered on patient insurance fields each time a different benefit is to be used or a different RX Bin is needed for the benefit to apply.

FIG. 5 is a block diagram showing the architecture of an illustrative computing device (500) that may be utilized in accordance with the system of FIG. 1. The computing device (500) may include certain standard hardware components, such as a central processing unit (CPU) (510), a data storage device (520) (e.g., hard drive, flash drive, removable drive), a read only memory (ROM) (530), a random access memory (RAM) (540), a clock (550), and a communications port (560). The CPU (510) is preferably linked to the other elements, by means of either a shared data bus, or dedicated connections, as shown in FIG. 5.

The CPU (510) may be embodied as a single processor, or a number of processors operating in parallel. The data storage device (520) and/or ROM (530) are operable to store one or more instructions, which the CPU (510) is operable to retrieve, interpret and execute. The CPU (510) preferably includes a control unit, an arithmetic logic unit (ALU), and a CPU local memory storage device, such as, for example, a stackable cache or a plurality of registers, in a known manner. The control unit is operable to retrieve instructions from the data storage device (520) or ROM (530). The CPU local memory storage device is operable to provide high-speed storage used for storing temporary results and control information.

The data storage device (520) may include a database. The communications port (560) connects to a network interface (570), thereby linking the computing device (500) with other devices. In addition, the communications port (560) may optionally connect to a printer (580), which may be utilized, among other things, to print statements, consumer information, labels, etc. The communications port 560 preferably includes multiple communication channels for simultaneously connecting with multiple parties.

Regarding the illustrative processor (500), numerous other general purpose or special purpose computing system environments or configurations may be used. Examples of well-known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules being executed by a computer, may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of aggregating and applying marketplace benefits to a claim for medicine, medical supplies or medical services, comprising:
receiving, from a retailer, a claim at an adjudicator, the claim including NCPDP claim information;
comparing the claim against an database of benefits aggregated to find a matching benefits program;
retrieving information from the database of benefits aggregated associated with the matching benefits program to create a new claim;
sending the new claim to a fulfillment entity of the matching benefits program;
updating the database of benefits aggregated to indicate the use of the fulfillment entity in the new claim; and
returning the new claim, as fulfilled by the fulfillment entity, to the retailer.

2. The method of claim 1, further comprising pre-populating consumer data at the retailer for transmitting with the claim.

3. The method of claim 2, further comprising associating the consumer data with a loyalty card.

4. The method of claim 3, wherein the loyalty card comprises one of a NCPDP formatted card, a mobile device, a Quick Response (QR) code, a display device, or a plastic card, or a paper card.

5. The method of claim 1, wherein the new claim comprises one of a new RX BIN, a benefit identifier (cardID), or a group identifier (groupID).

6. The method of claim 5, further comprising:
sending the new claim to the Rx BIN of the matched benefits program using information in the claim and information from the match benefits program in the database.

7. The method of claim 1, further comprising obtaining additional information during processing from a consumer.

8. A computer-readable storage medium comprising instructions which, when executed by a computer, perform a method of identifying and applying benefits to a transaction, the method comprising:
receiving at an adjudicator a claim for a benefit associated with the transaction from a user;
comparing the claim against a database of benefits to identify a matching benefit program;
retrieving information from the database of benefits associated with the matching benefit program;
creating a new claim based on the claim for the benefit and the information from the database of benefits;
sending the new claim to a fulfillment entity associated with matching benefit program;
returning the new claim, as fulfilled by the fulfillment entity, to the user; and
applying the new claim to the transaction.

9. The computer-readable storage medium of claim 8, wherein the user is at least one of a consumer, a retailer, and a service provider.

10. The computer-readable storage medium of claim 8, wherein the method of identifying and applying benefits to a transaction further comprises:
comparing the claim against the database of benefits to identify another matching benefit program;
retrieving information from the database of benefits associated with the other matching benefits program;
creating a second new claim based on the claim for the benefit and the information from the database of benefits;
sending the second new claim to another fulfillment entity associated with the other matching benefit program;
returning the second new claim, as fulfilled by the other fulfillment entity, to the user; and
applying the second new claim to the transaction.

11. The computer-readable storage medium of claim 10, wherein the method of identifying and applying benefits to a transaction further comprises:
comparing the new claim and the second new claim to identify an eligibility in applying both the new claim and the second new claim to the transaction;
applying the new claim and the second new claim to the transaction in accordance with a determined eligibility status.

12. The computer-readable storage medium of claim 8, wherein the method of identifying and applying benefits to a transaction further comprises:
storing in a claims database storing information associated with the user, information associated with the claim for benefit, and historical claim information associated with the user;
comparing the claim for benefit and the historical claim information to determine an eligibility of the user to apply the new claim to the transaction; and
applying the new claim to the transaction in accordance with a determined eligibility status.

13. The computer-readable storage medium of claim 8, wherein the database of benefits includes the claims database.

14. The computer-readable storage medium of claim 8, wherein the transaction is for the purchase of at least one of a medicine, a medical supply, and a medical services.

15. A computer-implemented method of identifying and applying benefits to a transaction comprising:
receiving at an adjudicator a claim for a benefit associated with the transaction from a user;
receiving at the adjudicator benefit information from a database of benefits;
comparing the claim with the benefit information to identify a matching benefit program;
retrieving claim information associated with at least one of the claim and the user;
creating a new claim based on the claim information and the benefit information;
sending the new claim to a fulfillment entity associated with the matching benefit program;
returning the new claim, as fulfilled by the fulfillment entity, to the user; and
applying the new claim to the transaction.

16. The computer-implemented method of claim 15, wherein retrieving claim information further includes querying the user to provide additional claim information.

17. The computer-implemented method of claim 15, wherein retrieving claim information further includes retrieving claim information from a benefit card;
wherein the benefit card is associated with at least one of a retailer loyalty program, a manufacturer loyalty program, and an insurance provider.

18. The computer-implemented method of claim 15, wherein comparing the claim with the benefit information to identify a matching benefit program further comprises comparing at least one of an RX BIN, a benefit identifier (cardID), and a group identifier (groupID) associated with each of the claim and the benefit information.

19. The computer-implemented method of claim 15, wherein sending the new claim to the fulfillment entity associated with the matching benefit program includes sending claim information to the Rx BIN of the matching benefits program.

20. The computer-implemented method of claim 15 further comprising:
updating the database of benefits to reflect a use of the matched benefit program associated with fulfillment of the new claim.
